(19) United States
(12) Patent Application Publication
(10) Pub. No.: US 2004/0221790 A1
(43) Pub. Date: Nov. 11, 2004

(54) Method and apparatus for optical odometry

(76) Inventors: Kenneth H. Sinclair, Newton, MA (US); Pace Gaillard Willisson, Medway, MA (US); Jay Loring Gainsboro, Framingham, MA (US); Lee Davis Weinstein, Arlington, MA (US)

Correspondence Address: LEE WEINSTEIN, 35 FAIRMONT ST #3, ARLINGTON, MA, 02474, US

(21) Appl. No.: 10/786,245

(22) Filed: Feb. 24, 2004

Related U.S. Application Data
(60) Provisional application No. 60/467,729, filed on May 2, 2003.

(51) Int. Cl. G01C 3/08; G01P 5/00; G01B 3/12; G01B 5/02; G01B 5/04; G01B 7/02; G01B 7/14; G01B 11/02; G01B 11/14; G01B 13/02; G06F 15/00; G01B 21/02; G01C 22/00

(52) U.S. Cl. 116/62.1; 702/165; 356/4.03

(57) ABSTRACT

A method and apparatus for optical odometry are disclosed which inexpensively facilitate diverse applications including indoor/outdoor vehicle tracking in secure areas, industrial and home robot navigation, automated steering and navigation of autonomous farm vehicles, shopping cart navigation and tracking, and automotive anti-lock braking systems. In a preferred low-cost embodiment, a telecentric lens is used with an optical computer mouse chip and a microprocessor. In a two-sensor embodiment, both rotation and translation are accurately measured.

This application claims priority to provisional application No. 60/463,525, filed Apr. 17, 2003, titled “Method and Apparatus for Optical Odometry”.

### FIELD OF THE INVENTION

The field of the invention relates to odometry, image processing, and optics, and more specifically to optical odometry.

### BACKGROUND OF THE INVENTION

The dictionary defines an odometer as an instrument for measuring distance, and gives as a common example an instrument attached to a vehicle for measuring the distance that the vehicle travels. Indeed an odometer is a legally required instrument in all commercially sold vehicles. In passenger cars, the odometer may serve several useful functions. In one application, as a consumer purchases a used car, the odometer reading allows the consumer to measure how “used” a car actually is. In another application, a consumer may use a car odometer as a navigation aid when following a set of driving directions to get to a destination. In another application, a consumer may use odometer readings as an aid in calculating tax-deductible vehicle expenses.

Typical passenger car odometers function by directly measuring the accumulated rotation of the vehicles wheels. Such a direct-mechanical-contact method of odometry is reliable in applications where direct no-slip mechanical contact is reliably maintained between the vehicle (wheels, treads, etc.) and the ground. In aircraft and ships, odometry is more typically accomplished through means such as GPS position receivers. For ground-based vehicles which experience significant wheel-slip in ordinary operation (such as farm vehicles, which may operate in mud), wheel-rotation odometry is not necessarily an accurate measure of distance traveled (though it is certainly an adequate measure of wear on machinery). Some companies engaged in the design of new autonomous agricultural vehicles have attempted to use GPS odometry, and have found it not to be accurate enough for many applications. Even when high-precision differential GPS measurements are employed, the time latency between receiving the GPS signal and deriving critical information such as velocity can be too long to allow GPS odometry to be used in applications such as velocity-compensated spreading of fertilizer, herbicides, and pesticides in agricultural applications. In addition, occasional sporadic errors in derived GPS position could make the difference between an autonomous piece of farm equipment being just outside your window, or in your living room.

### SUMMARY OF THE INVENTION

In a preferred embodiment, the present invention measures change and position by measuring movement of features in a repeatedly-electronically-captured optical image of the ground as seen from a moving vehicle. In one embodiment, a downward-looking electronic imager is mounted to a vehicle. A baseline image is taken, and correlation techniques are used to compare the position of features in the field of view in subsequent images to the position of those features in the baseline image. Once the shift in image position becomes large enough, a new baseline image is taken, and the process continues. In an alternate embodiment, an integrated optical navigation sensor (such as is used in an optical computer mouse) is fitted with optics to look at the ground below a moving vehicle. The optics provide the optical navigation sensor with an appropriately scaled image of a portion of the surface over which the vehicle is traveling, where the image is sufficiently in-focus that the navigation sensor can discern movement of surface texture features to produce accurate incremental X and Y position change information. Whether natural or artificial illumination is used, it is preferable in most applications that the optics give minimal attenuation to the portion of the illumination spectrum to which the image sensor is most sensitive.

The incremental X and Y position-change information from the navigation sensor is scaled and used as vehicle position change information. The system has no moving parts and is extremely mechanically rugged. In a preferred embodiment for use in dirty environment where airborne particles and moisture are present, a small optical aperture is used and the optical measurement is made through a hole through which an outward airflow is maintained to prevent environmental dirt or moisture from coming in contact with the optics. In another preferred embodiment for use in dirty environments, system optics are sealed in a housing and look out through a window which is automatically continuously cleaned (as in an embodiment with a rotating window with a stationary wiper) or periodically cleaned (as in an embodiment with a stationary window and a moving periodic wiper).

In a preferred high-accuracy embodiment, a telecentric lens is used to desensitize the system to image-scaling-related calculation errors. In an alternate preferred embodiment, height measuring means 108 are provided to sense height variations during operation, and image scaling distortion is estimated on the fly by normalizing the scaling of image data based on sensed height over the imaged surface. In an alternate preferred embodiment, dynamic height adjusting means 109 is driven to maintain a constant output from height measuring means 108 so as to maintain imager 103 at a constant height above the surface being imaged, and thus maintain a constant image scale factor.

Height measuring means 108 may be optical or acoustic, or it may be electromechanical, or opto-mechanical. In the prior art, scale-variation-induced errors have been considered such a problem in the use of optical navigation sensors that the technical help staff of Agilent recommend against the use of the company's integrated optical navigation sensor for motion-sensing applications other than highly constrained applications such as a computer mouse.

It is an object of the present invention to provide an inexpensive, robust, earth-referenced method of odometry with sufficient accuracy to facilitate navigation of autonomous agricultural equipment, and sufficient accuracy to derive real-time vehicle velocity with enough precision to facilitate highly accurate automated velocity-compensated application of fertilizer, herbicides, pesticides, and the like in agricultural environments. It is a further object of the present invention to provide accurate vehicle odometry information, even under conditions were vehicles wheels are slipping. It is a further object of the present invention to facilitate improved anti-skid safety equipment on cars and trucks. It is a further object of the present invention to facilitate improved-performance wheeled vehicles in general, by facilitating improved traction control systems. It is a further object of the present invention to facilitate improved performance in all manner of ground-contact vehicles, by facilitating improved traction control systems, including anti-lock braking systems. It is a further object of the present invention to facilitate tracking and historical position logging of ground-traversing animals and objects, both indoors and outdoors. It is a further object of the present invention to provide increased accuracy of optical navigation sensors under conditions where the distance from the optical sensor to the surface being sensed is variable and imprecisely known. It is a further object of the present invention to facilitate inexpensive, reliable indoor navigation and odometry with bounded total error accumulation over time. It is a further object of the present invention to provide tracking and position sensing and related security data reporting for vehicles in combined outdoor/indoor applications. It is a further object of the present invention to facilitate inexpensive stress monitoring and historical and/or real-time tracking of loaned or rented vehicles. It is a further object of the present invention to facilitate tracking and navigation in indoor environments such as supermarkets, hospitals, and airports. It is a further object of the invention to facilitate automated steering systems for autonomous and manned vehicles.

### BRIEF DESCRIPTION OF THE DRAWINGS

FIG. 1A depicts a side view of a preferred embodiment of the present invention mounted on the front of a moving vehicle.

FIG. 1B depicts a side view of a preferred embodiment of the present invention mounted underneath a moving vehicle.

FIG. 2 depicts a set of example pixel-pattern images acquired by the downward-looking electronic imager of the present invention.

FIG. 3A depicts a bottom view of a vehicle equipped with a two-imager embodiment of the present invention, enabling high-resolution measurement of vehicle orientation change as well as vehicle position change.

FIG. 3B depicts a set of example pixel-pattern images acquired by downward-looking imagers C1 and C2.

FIG. 4 depicts (for an an example acceleration and deceleration of a vehicle utilizing the present invention) the relationship between actual position, raw GPS readings, and the output of a Kalman filter used to reduce noise in raw GPS readings.

FIG. 5 depicts (for the same acceleration profile used in FIG. 4) the GPS position error of the output of the Kalman filter, the GPS velocity derived from the output of the Kalman filter, and the GPS velocity error.

FIG. 6 depicts a shopping cart equipped with the present invention.

FIG. 7 depicts the layout of a grocery store equipped to provide automated item location assistance and other features associated with the present invention.

FIG. 8 depicts a comparison between the optical behavior of a telecentric lens and the optical behavior of a non-telecentric lens.

FIG. 9 is a schematic diagram of a preferred embodiment of an optical odometer utilizing one or more electronic image capture sensors.

FIG. 10 is a schematic diagram of a preferred embodiment of an optical odometer utilizing one or more integrated optical navigation sensors.

### DETAILED DESCRIPTIONS OF THE PREFERRED EMBODIMENTS

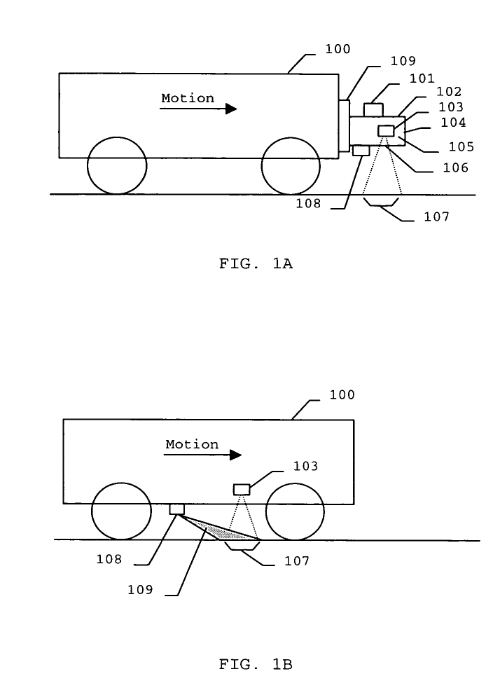

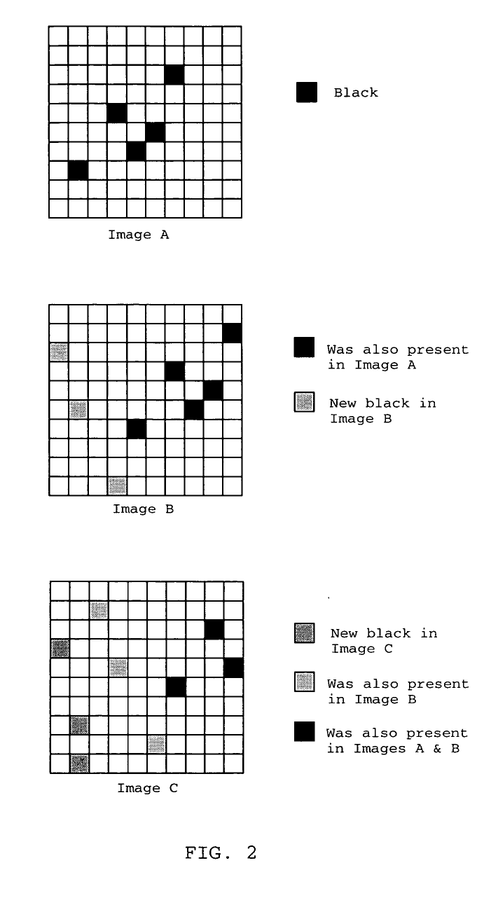

FIG. 1A depicts a preferred embodiment of the imaging system of the present invention mounted on the front of the moving vehicle 100. Electronic imager 103 is mounted inside protective housing 104, which is filled with pressurized air 105, which is supplied by filtered air pump 101. Electronic imager 103 looks out of housing 102 through open window 106, and images field of view that is just beneath the front of moving vehicle V. Electronic imager 103 may be a black & white video camera, color video camera, CMOS still image camera, CCD still image camera, integrated optical navigation sensor, or any other form of imager that converts an optical image into an electronic representation. Sequentially acquired images are stored in computer memory. Data derived from sequentially acquired images is stored in computer memory. Within this document, the term “computer memory” shall be construed to mean any and all forms of data storage associated with digital computing, including but not limited to solid-state memory (such as random-access memory), magnetic memory (such as hard disk memory), optical memory (such as optical disk memory), etc.

In dirty environments such as may be present around farm machinery, it is important to keep dirt from getting on the optics of the system in order to maintain accuracy. Accuracy is somewhat impaired by airborne dirt, mist, etc., but need not be cumulatively degraded by allowing such contaminants to accumulate on the optics. The continuous stream of pressurized air flowing out through window 106 serves to prevent contamination of the optics, thus limiting the optical “noise” to any airborne particles momentarily passing through the optical path. In FIG. 1A, natural lighting is relied upon to illuminate the field of view.

FIG. 1B depicts the preferred embodiment the present invention where electronic imager 103 looks out from beneath moving vehicle 100 at field of view 107, and field of view 107 is lit by lighting source 108, which is projected at an angle of approximately 45 degrees with respect to the vertical. By ensuring that a substantial fraction of the light illuminating the field of view comes from a substantial angle from the vertical, shadow detail in the image is enhanced.

FIG. 2 depicts three high-contrast pixel images acquired sequentially in time from electronic imager 103. For the purposes of this illustration it is assumed that each pixel in the image is either black or white. Five black pixels are shown in image A, which is taken as the original baseline image. In image B, the pattern of 5 black pixels originally seen in image A is seen shifted to the right by three pixels and up by one pixel indicating corresponding motion of the vehicle in two dimensions. In addition, three new black pixels have moved into the field of view in image B. In image C, two of the original black pixels from image A are no longer in the field of view, all of the black pixels from image B are still present, and three new black pixels have come into the field of view. It can be seen that the pixels in image C which remain from image B have moved two pixels to the right and one pixel up, again indicating motion of the vehicle in two dimensions.

In a preferred embodiment of the present invention, image A is taken as an original baseline position measurement. Relative position is calculated at the time of acquiring image B, by comparing pixel pattern movement between image A and image B. Many intermediate images may be taken and processed between image A and image B, and the relative motion in all of these intermediate images will be digitally calculated (by means such as a microprocessor, digital signal processor, digital application-specific integrated circuit, or the like) with respect to image A. By the time image C is acquired, a substantial fraction of the pixels which were originally present in image A are no longer present, so to maintain a reasonable level of accuracy, image B is used as the new baseline image, and relative motion between image B and image C is measured using image B is a baseline image.

In a preferred embodiment of the present invention a number of images taken subsequent to the establishment of one baseline image and prior to the establishment of the next baseline image are stored, and a selection algorithm selects from among these stored images which image to used as the new baseline image. The selection is done in such a way as to choose a new baseline image with the highest signal to noise ratio available, where “signal” includes pixels which are believed to be part of a consistent moving image of the ground, and “noise” includes pixels which are believed to be representative of transient objects moving through the field of view (such as leaves, airborne bits of dirt etc.).

In one application, the present invention may be used to perform odometry on autonomous agricultural machinery, aiding in automated navigation of that machinery. In a preferred embodiment, position information from the present invention is combined with GPS position information, resulting in high accuracy in both long-distance and short-distance measurements.

In another application, the present invention is used to provide extreme high accuracy two-dimensional short distance odometry on a passenger car. When combined with wheel rotation sensors, the present invention enables accurate sensing of skid conditions and loss of traction on any wheel.

In a preferred embodiment of the present invention, a solid-state video camera is used to acquire the sequential images shown in FIG. 1. Although the contrast of images shown in FIG. 1 is 100% (pixels are either black or white), a grayscale image may also be used. When a grayscale image is used, the change in darkness of adjacent pixels from one image to the next may be used to estimate motion at a sub-pixel level. For maximum accuracy, it is desirable to use an imaging system with a large number of pixels of resolution, and to re-establish baseline images as far apart as possible. In a preferred embodiment of the present invention, spatial calibration of the imaging system may be performed to improve accuracy and effectively reduce distortion.

In an alternate preferred embodiment of the present invention, an integrated optical navigation sensor (such as is found in a typical optical computer mouse) is used as imaging device 103 in FIG. 1, and X and Y motion is estimated internal to the integrated optical navigation sensor. In such an embodiment, digital processing is performed on x and y motion data output from one or more integrated optical navigation sensors over time.

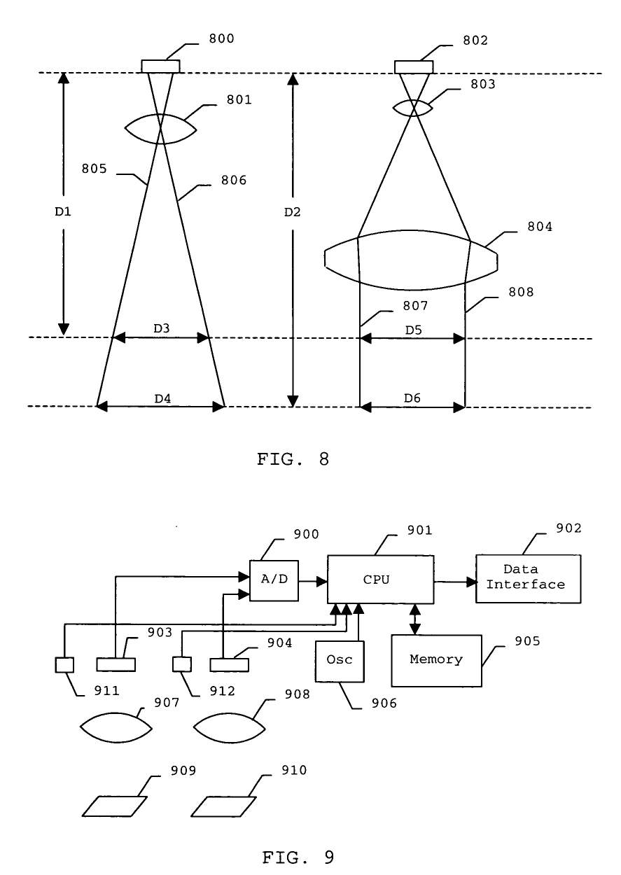

FIG. 9 is a schematic diagram of a preferred embodiment of an optical odometer according to the present invention. Optics 907 is positioned to image portion 909 of a surface onto image sensor 903. The potion of the surface imaged varies as the position of the optical odometer varies parallel to the surface. Electronically captured images from image sensor 903 are converted to digital image representations by analog-to-digital converter (A/D) 900. Data from sequentially captured images is processed in conjunction with timing information from clock oscillator 906 by digital processor 901 in conjunction with memory 905, to produce position and velocity information to be provided through data interface 902. Since the odometers accuracy will be at best the accuracy of clock oscillator 906, clock oscillator 906 may be any electronic or electromechanical or electro-acoustic oscillator who's frequency of oscillation is stable enough that any inaccuracy it contributes to the system is acceptable. In a preferred embodiment, clock oscillator 906 is a quartz-crystal-based oscillator, but any electronic, electromechanical, electro-acoustic oscillator or the like with sufficient accuracy can be used.

In applications where it is desirable for position and velocity information to include more accurate orientation information and rotational velocity information, additional image sensor 904 and optics 908 may be provided to image additional portion 910 of the surface over which the optical odometer is traveling. In applications where image sensor height variation with respect to the surface being imaged could induce undesired inaccuracies, height sensors 911 and 912 are added to either allow calculating means 901 to compensate for image-scale-variation-induced errors in software, or to electromechanically adjust sensor heights dynamically to maintain the desired constant image scale factor.

In an alternate preferred embodiment shown in FIG. 10, an integrated optical navigation sensor 1000 (such as is used in an optical mouse) is used and X & Y motion data from the integrated optical navigation sensor is processed by distance calculating means 901. In such an embodiment, if more accurate orientation and rotational velocity information is desired, a second integrated optical navigation sensor 1001 imaging a second portion of the surface over which the optical moves may be added. For applications where height-variation-induced image-scale variations would compromise accuracy, optics 907 and 908 may be made substantially telecentric, and/or electromechanical height actuators 1002 and 1003 may be driven based on height measurement feedback from height sensors 912 and 911 (respectively) to maintain integrated optical navigation sensors 1001 and 1000 (respectively) and optics 908 and 907 (respectively) at consistent heights above the imaged surface to maintain the desired image scale factors at the integrated optical navigation sensors.

Digital processor 901 serves as distance calculating means and orientation calculating means in the above embodiments, and may be implemented as a microprocessor, a computer, a digital signal processing (DSP) chip, a custom or semi-custom digital or mixed-signal chip, or the like.

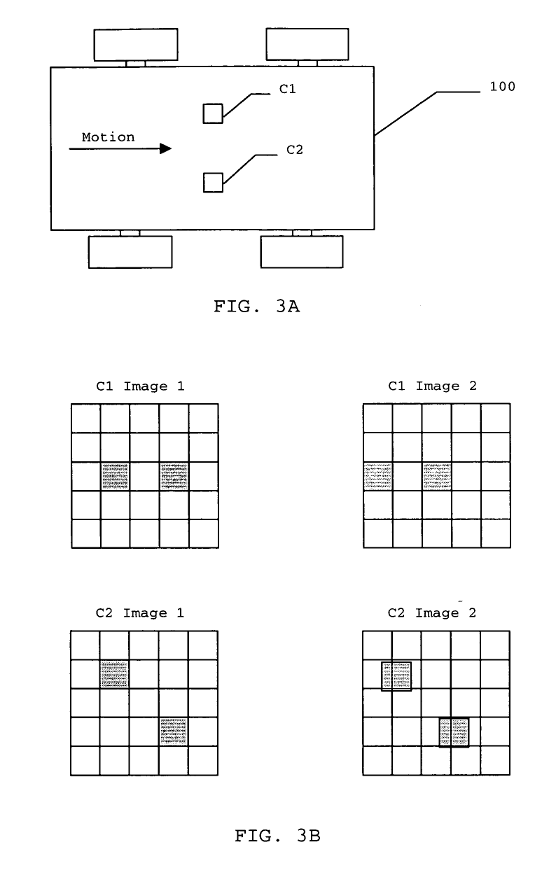

FIG. 3 depicts a vehicle equipped with a two-imager embodiment of the present invention, enabling high-resolution measurement of vehicle orientation change as well as vehicle position change. In a preferred embodiment, electronic imagers C1 and C2 are spaced far apart about the center of vehicle V, each imager downward-facing with a view of the ground over which vehicle 100 is traveling. Accurate two-dimensional position change information at imager C1 may be combined with accurate two-dimensional position change information at imager C2 to derive two-dimensional position and orientation change information about moving vehicle V. While orientation change information could be obtained from sequential changes in the image from either imager alone, use of two imagers allows highly accurate rotational information to be derived using imagers with relatively small fields of view. Treating movement of the images from each imager as (to a first approximation) consisting of only linear motion, and then deriving rotation from the linear motion sensed at each imager, a second (higher accuracy) linear motion measurement can be made at each imager once the first-order rotation rate has been estimated and can be compensated for.

In FIG. 3, the sequential images C1 Image 1 and C1 Image 2 taken from imager C1, and the sequential images C2 Image 1 and C2 Image 2 taken from imager C2 indicate that vehicle 100 is moving forward and turning to the right, because the rate of movement of the image seen by the right imager (C2) is slower than the rate of movement seen by the left imager (C1).

Orientation change information may be useful for applications including autonomous navigation of autonomous agricultural equipment, automated multi-wheel independent traction control on passenger cars (to automatically prevent vehicle rotation during emergency co braking), etc.

Other applications for the present invention include tread-slip prevention and/or warning systems on treaded vehicles (such as bulldozers, snowmobiles, etc.), traction optimization systems on railway locomotives, position measurement in mineshafts, weight-independent position measurements for shaft-enclosed or tunnel-enclosed cable lifts and elevators, race car position monitoring in race-track races (where an optical fiducial mark such as a stripe across the track can be used to regain absolute accuracy once per lap), race car sideways creep as an indicator of impending skid conditions, navigation of autonomous construction vehicles and autonomous military vehicles, odometry and speed measurement and path recording for skiers, odometry and speed measurement and remote position tracking for runners in road races, automated movement of an autonomous print-head to print on a large surface (such as the a billboard, or the side of a building (for example for robotically painting murals), or a wall in a house (for example for automatically painting on wall-paper-like patterns)), replacement for grit-wheel technology for accurately repositioning paper in moving-paper printers, automated recording of and display of wheel-slip information for race car drivers, automated position tracking and odometry of horses in horse races, and automated navigation for road-striping equipment.

When combined with a measurement which gives distance-above-bottom, the present invention can also be used for automated underwater two-dimensional position tracking for scuba divers, and automated navigation and automated underwater mapping and photography in shallow areas (for instance to automatically keep tabs on reef conditions over a large geographic area where a lot of sport diving takes place).

A preferred embodiment of the present invention used in a robotic apparatus for automatically painting advertising graphics on outdoor billboards further comprises automatic sensing of the color of the surface being painted on, so that only paint dots of the color and size needed to turn that color into the desired color (when viewed from a distance) would be added, thus conserving time, paint, and money.

In preferred embodiment where airborne contaminants which could compromise the optics of electronic imager 103, a small-aperture optics system (such as the system previously described which looks out through a small hole in an air-pressurized chamber) is used. In preferred embodiments where high accuracy is needed in situations where the imaged surface is unpredictably uneven at a macroscopic level, an optical system employing a telecentric lens is employed.

The optical behavior of a telecentric lens is compared with the optical behavior of a non-telecentric lens in FIG. 8. FIG. 8 illustrates optical ray tracing through a non-telecentric lens 801 with optical ray tracing through a telecentric lens group comprising lens 803 and lens 804. Note that to traverse the field of view seen by image sensor 800, and object at distance D1 from imager 800 need only travel distance D3, whereas an object at distance D2 from Imager 800 must travel distance D4, where Distance D4 is greater than distance D3.

In contrast, note that to traverse the field of view seen by image sensor 802, and object at distance D1 from imager 802 travels a distance D5, and an object at distance D2 from Imager 802 travels a distance D6, where distances D5 and D6 equal. Thus objects traversing the field of view close to a telecentric lens at a given velocity move across the image at the same rate as objects traversing the field of view further from the lens at the same velocity (unlike a conventional lens, where closer objects would appear to traverse the field of view faster)

It is also possible to design a lens system that has more telecentricity than a regular lens, but not as much telecentricity as a fully telecentric lens. To see this, note that the geometry of lens 804 could be altered such that rays 807 and 808 were not parallel, but were still more parallel than rays 805 and 806. In an optical odometer application where the distance between the surface being imaged and the imager is not precisely known, increasing the degree of telecentricity of the optics of the imager increases the accuracy of the optical odometer. A degree of telecentricity sufficient to reduce the potential error in a given application by 30% would be considered for the purposes of this document to be a substantial degree of telecentricity.

Since it is an optical requirement that the aperture of a telecentric lens be as big as its field of view, the optical aperture through which imager 103 acquires its image may be larger in preferred embodiments where high accuracy optical odometry is desired on unpredictably uneven surfaces, such as may be the condition in agricultural applications, underwater applications, etc.

In a preferred embodiment for use in precision farming, optical odometry is combined with GPS position sensing. Optical odometer readings provide accurate high-bandwidth velocity measurements, allowing more precise rate-compensated application of fertilizer and other chemicals than would be possible using GPS alone.

In FIG. 4, position profile 400 depicts an ideal accurate plot of position versus time for a piece of farm equipment moving in a straight line, first undergoing acceleration, then deceleration, then acceleration again. Profile 401 depicts the raw GPS position readings taken over this span of time from a GPS receiver mounted on the moving equipment. Profile 402 depicts the output of a Kalman filter designed to best remove the noise from the GPS position signal. Because any filter designed to remove the noise from a noisy signal must look at the signal over some period of time to estimate and remove the noise, there is an inherent latency, and thus the output of the filter will at best be a delayed version of the ideal signal (in this case a position and/or velocity signal).

In FIG. 4, profile 400 depicts the actual time vs. position of a farm vehicle along an axis of motion, as the machine accelerates, decelerates, and accelerates again. Profile 401 represents the noisy, slightly delayed “raw” output from a GPS receiver mounted on the moving vehicle. Profile 402 depicts a Kalman filtered version of profile 401.

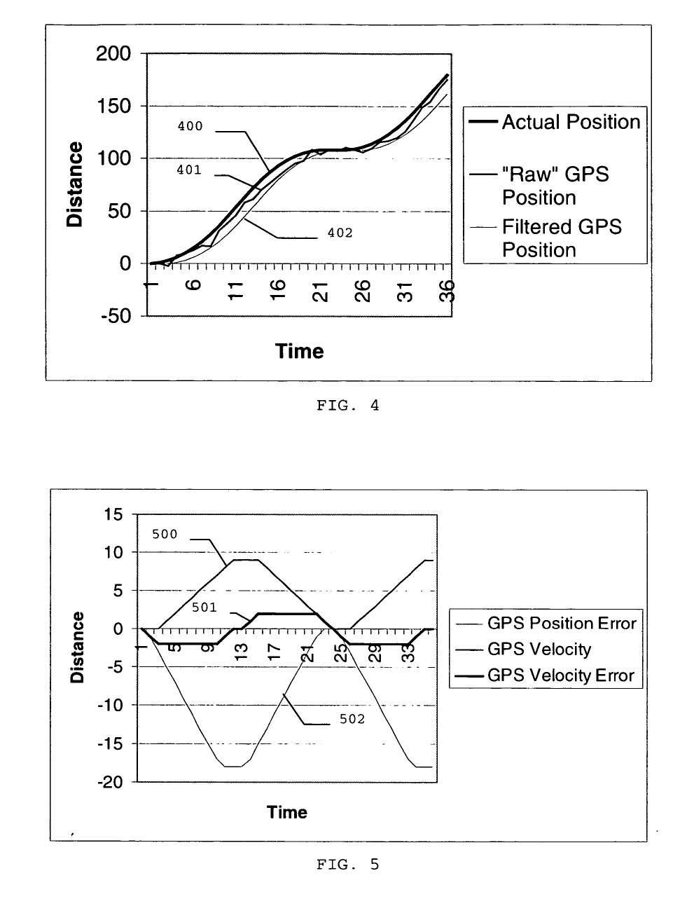

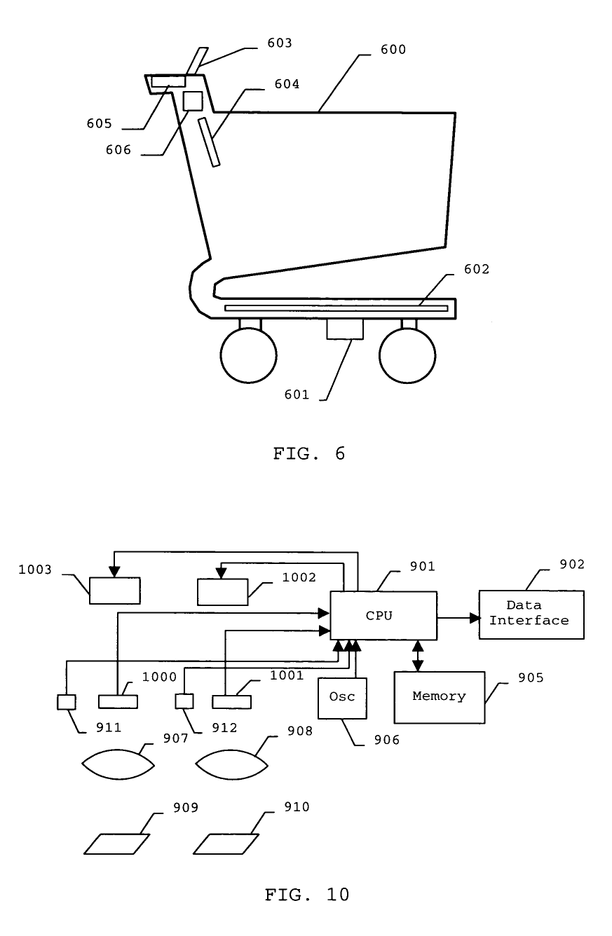

In FIG. 5, profile 500 depicts the actual real-time velocity vs. time for the position-time profile 400. Profile 501 depicts the GPS position velocity error (at the Kalman filtered output), and profile 502 depicts the GPS velocity error. Using optical odometry in combination with GPS according to the present invention, the combined position error and the combined velocity error may be reduced to negligible values.

A delay in the feedback path of a control system can be thought of as limiting the bandwidth of the control system. GPS systems such as differential GPS may be used to provide absolute position information to within a finite bounded accuracy, given enough time. In the frequency domain, this can be thought of as position information that is usable down to DC, but is not usable for the needed spatial accuracy above some certain frequency.

Since an optical odometer is inherently a differential measurement device, it accumulates error over distance. Thus over long periods of use, in the absence of fiducials to reset absolute accuracy, an optical odometer accumulates error without bound. Thus, in the frequency domain, an optical odometer can be thought of as providing information of sufficient accuracy above a certain frequency, and not below that frequency. In a preferred embodiment of the present invention for use in precision farming, information from an optical odometer (sufficiently accurate above a given frequency) is combined with information from a GPS receiver (sufficiently accurate below a given frequency) to provide position information which is sufficiently accurate absolute position information across all frequencies of interest.

One aspect of precision farming where accurate position and velocity information is desirable at a higher bandwidth than can be obtained from GPS alone is the precise position-related control of concentration of fertilizer and other chemicals. Position and velocity errors in the outputs of GPS systems during acceleration and deceleration (such as the errors shown in FIG. 4) can lead to poor control of chemical deposition, and may lead to unacceptable chemical concentrations being applied.

Another aspect of precision farming where the present invention has great utility is automatic steering. It is desirable in a number of applications in farming to drive machines in a line as straight as possible. Straighter driving can facilitate (for instance) tighter packing of crop rows, more efficient harvesting, etc. Due to unevenness of terrain and spatial variations in soil properties, maintaining a straight course can take more steering in agricultural situations than on a paved surface. In addition, the abruptness of some changes in conditions can call for fast response if tight tolerances are to be maintained. Typical response delays for human beings are in tenths of a second, whereas automated steering systems designed using the present invention can offer much higher bandwidth. Thus, the present invention may be used to maintain equipment on a straighter course than would be possible under unassisted human control, and a straighter course than would be possible under currently available GPS control.

In a preferred embodiment of the present invention, optical odometry is used in conjunction with optically encoded fiducial marks to provide position tracking and navigation guidance in a product storage area such as a warehouse or a supermarket. In one particularly economical embodiment employing integrated optical navigation sensors, optical stripe fiducials may be detected by processing the brightness output from the integrated optical navigation sensor chips.

In other indoor/outdoor embodiments of the present invention (such as embodiments facilitating the tracking luggage-moving vehicles and the like at airports, various types of fiducials may be used to periodically regain absolute position accuracy. Such fiducials may be optical (such as optically coded patterns on surfaces, which may be sensed by the same image sensors used for optical odometry), or they may be light beams, RF tags, electric or magnetic fields, etc., which are sensed by additional hardware.

FIG. 6 depicts a supermarket shopping cart used in a preferred embodiment for use within a retail store. Optical odometer unit 601 is affixed to one of the lower rails of shopping cart 600, such that the optics of optical odometer unit 601 images part of the floor beneath shopping cart 600. Electrical contact strips 602 on the inside and outside of both lower shopping cart rails connect shopping carts in parallel for recharging when shopping carts are stacked in their typical storage configuration. In an alternate preferred embodiment, power is generated from shopping cart wheel motion to power all the electronics carried on the cart, so no periodic recharging connection is required. Scanner/microphone wand 604 serves a dual purpose of scanning bar codes (such as on customer loyalty cards and/or product UPC codes) and receiving voice input (such as “where is milk?”). Display 603 provides visual navigation information (such as store map with the shopper's present position, and position of a needed item) and text information (such as price information, or textual navigation information such as “go forward to the end of the isle, then right three isles, right again, and go 10 feet down the isle, third shelf up”), and may also provide this information in audio form. The word “displaying” as used in the claims of this document shall include presenting information in visual and/or audio form, and a “display” as referred to in the claims of this document shall include not only visual displays capable of displaying text and/or graphics, but also audio transducers such as speakers or headphones, capable of displaying information in audio form. Keyboard 605 serves as an alternate query method for asking for location or price information on a product. Wireless data transceiver 606 communicates with a hub data transceiver in the supermarket, and may comprise wireless Ethernet transceiver or the like. It is contemplated that the present invention can be used equally well in any product storage area, including not only retail stores, but warehouses, parts storage facilities, etc.

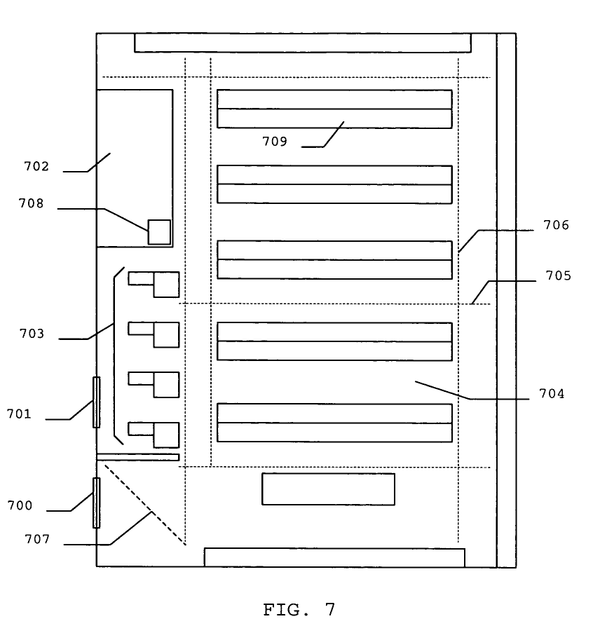

FIG. 7 depicts a floor layout of a supermarket in an embodiment of the present invention, including entrance door, 700, exit door 701, and office and administrative area 702. Optically encoded fiducial patterns 705 encode reference positions along the “Y” axis in the store, and optically encoded fiducial patterns 706 encode reference positions along the “X” axis in the store. Diagonal fiducial pattern 707 provides initial orientation information when a shopping cart first enters the store, and as soon as the shopping cart crosses the first “X” fiducial, X position is known from the X fiducial and Y position is known from the known path traveled from the crossing of diagonal fiducial 707, and the unique distance between diagonal 707 and the first X fiducial for any given Y where the diagonal was first crossed. In a preferred embodiment, optical odometry maintains accuracy of about 1% of distance traveled between crossing fiducial marks, and position accuracy in the X and Y directions are reset each time X and Y fiducial marks are crossed, respectively. Information about product position on shelves 709 and isles 704 is maintained in central computer system 708.

In a preferred embodiment, the orientation of the shopping cart is taken into account automatically to estimate the position of the consumer who is pushing the cart, and all navigation aids are given relative to the estimated position of the consumer, not the position of the optical odometer on the cart. Thus, if the consumer turns the cart around such that optical odometer unit 601 rotates about its vertical axis, the assumed position of the consumer would move several feet. This allows automated guiding of a consumer to be within a foot of standing in front of the product he or she is seeking.

In a preferred embodiment, the path a consumer takes through the store and the information the consumer requests through barcode/microphone wand 604 and keyboard 605 are stored as the consumer shops, and as the consumer enters a checkout lane, wireless data transmitter 606 transmits to central computer 708 the identity of the cart which has entered the check-out lane, and the product purchase data from automated product identification equipment (such as UPC barcode scanners, RFID tag sensors, etc.) at checkout registers 703 is correlated with shopping path and timing information gathered from the optical odometer on the consumer's shopping cart, providing valuable information which can be used in making future merchandising decisions on positions of various products within the store.

In a preferred embodiment, barcode scanner wand 604 may be used by the consumer to simply scan the barcode of a coupon, and display 603 will automatically display information guiding the consumer to the product to which the coupon applies. In a preferred embodiment, barcode wand 604 or display 603 or keyboard 605 may also incorporate an IR receiver unit to allow consumers to download a shopping list from a PDA, and path optimization may automatically be provided to the consumer to minimize the distance traveled through the store (and thus minimize time spent) to purchase all the desired items.

In a preferred embodiment, advice is also made available through display unit 603, in response to queries such as “dry white wine”. Applications of optical odometry:

Navigating in a warehouse.

Airport luggage cart that would guide you to your gate.

Self-guided robotic lawn mowers.

Navigation of home robot after it has learned the environment of your house.

Localization and navigation system for blind person for an enclosed area or outdoors.

Automated navigation in buildings like hospitals to get people to where they want to go.

Tracking and reporting patient position in hospitals and nursing homes.

Toilet paper and paper towel usage measurement.

Measurement of velocities in fabric manufacture.

Using motion information while acquiring a GPS signal or in between loosing and re-acquiring a GPS signal, such that change in position is taken into account such that accurate position estimates can speed up acquisition process.

Tracking pets such as dogs and cats.

Tracking vehicle position at airports and on military bases, including inside buildings where GPS won't work.

Tracking or guiding people at amusement parks such as Disney World.

Training of race car drivers.

Training during bobsledding & luge.

Market research applications on shopping carts.

Rental vehicle stress monitoring (speed, acceleration).

Vehicle monitoring for parents (monitoring kids' speed, acceleration, routes).

Navigation for scuba divers.

Skateboard odometer.

Railroad train odometer.

Variable-rate application of pesticides, herbicides, fertilizer, and the like, such as in precision farming applications.

Agricultural yield mapping combining harvest yield information with position information.

Assisted or automatic steering of tractors in applications such as precision farming.

Bounded absolute accuracy may be obtained by combining fiducial marks with optical odometry for increased absolute position and distance accuracy. One method of recognizing fiducial marks comprises including contrast patterns (such as stripes) in the field of view of the optical odometry imaging system at known locations, such that the fiducials are sensed as part of optical odometer image capture process. Another method of recognizing fiducial marks comprises recognizing fiducial features with a separate image recognition video system, and combining with optical odometry. Another method of recognizing fiducial marks comprises recognizing fiducial reference light beams and combining with optical odometry. Other fiducial recognition systems include recognizing one or two dimensional bar codes, electric field sensing or magnetic field sensing which encode absolute position information.

The foregoing detailed description has been given for clearness of understanding only, and no unnecessary limitation should be understood therefrom, as modifications will be obvious to those skilled in the art.

What is claimed is:

1. An optical odometer system for measuring travel over a surface, comprising:
an electronic image sensor having freedom of motion parallel to said surface in at least one dimension;
optics coupled to said image sensor so as to image a portion of said surface onto said image sensor at a known scale factor;
an analog-to-digital converter for converting a sensed image to digital form;
computer memory for storing data derived from sequentially captured digital images;
a clock oscillator for providing a time reference; and
distance calculating means for calculating distance traveled with respect to said surface between sequentially captured digital images.

2. The optical odometer system of claim 1, further comprising orientation calculation means for calculating orientation changes between said sequentially captured digital images.

3. The optical odometer system of claim 1, further comprising an optically detectable fiducial mark, and means for automatically sensing position relative to said fiducial mark.

4. The optical odometer system of claim 1, wherein said surface comprises the floor of a product storage area and further comprises a fiducial mark, and wherein said electronic imager and said optics are affixed to a product transport mechanism, and further comprising means for automatically sensing the presence of said fiducial mark and means for subsequently measuring position relative to said fiducial mark.

5. A method of optical odometry comprising the steps of:
mounting optics operably coupled to an electronic imager on a mobile object capable of motion with at least one degree of freedom parallel to a surface, such that said optics focus an image of a portion of said surface onto said electronic imager at a known scale factor, said portion of said surface varying with the position of said object;
acquiring a sequence of electronic images at known times through said imager;
converting said sequence of electronic images to a sequence of data sets; and
digitally processing said sequence of data sets in conjunction with said scale factor to measure distance traveled by said object in at least one dimension.

6. The optical odometer system of claim 2, wherein said optics comprise a substantially telecentric lens.

7. The optical odometer system of claim 2, further comprising means for measuring changes in the distance of said optics from said surface over time.

8. The optical odometer system of claim 2, further comprising means for stabilizing the distance of said optics from said surface over time.

9. A method of providing automated shopping assistance, comprising:
using an optical odometer attached to a shopping cart to track motion of said shopping cart through a retail store; and
displaying information of potential use to a consumer 0 through a display on said shopping cart.

10. The method of claim 9, further comprising the step of receiving an information request from a consumer and automatically displaying information in response to said information request.

11. The method of claim 9, further comprising the step of receiving a shopping list of items from a consumer in electronic or barcode form and displaying information of potential use to said consumer regarding said items.

12. The method of claim 9, wherein said information of potential use to said consumer comprises advertising information dependent on the position of said consumer within said store.

13. The method of claim 10, wherein said information of potential use to said consumer comprises advertising information related to an information request made by said consumer.

14. The method of claim 11, wherein said information of potential use to said consumer comprises advertising information related to a shopping list input by said consumer.

15. The method of claim 11, wherein said information of potential use to said consumer comprises location information regarding said items.

16. An optical odometer system for measuring travel over a surface, comprising:
an integrated optical navigation sensor having freedom of motion parallel to said surface in at least one dimension;
optics coupled to said image sensor so as to image a portion of said surface onto said electronic image sensor at a known scale factor;
a clock oscillator for providing a time reference; and
distance calculating means for calculating distance traveled with respect to said-surface based data output from said integrated optical navigation sensor.

17. The optical odometer system of claim 16 wherein said optics comprise a substantially telecentric lens.

18. A method of optical odometry comprising the steps of:
mounting optics operably coupled to an integrated navigation sensor on a mobile object capable of motion with at least one degree of freedom parallel to a surface, such that said optics focus an image of a portion of said surface onto said electronic imager at a known scale factor, said portion of said surface varying with the position of said object, and said image being of a known scale relative to said portion of said surface; and
digitally processing data output from said optical navigation sensor to derive distance traveled by said object in at least one dimension.

19. The method of claim 18, further comprising digitally processing data output from said integrated navigation sensor to derive velocity of said object in at least one dimension.

20. The optical odometer system of claim 4, wherein said product storage area comprises a retail store which includes a checkout counter, and wherein said product transport mechanism comprises a shopping cart.

21. The optical odometer system of claim 20, further comprising a wireless data link, a database containing positional information for products within said store, automated product identification equipment at said checkout counter, and means affixed to said shopping cart for displaying the location of products within said store.

22. The optical odometer system of claim 21, further comprising means for deriving and storing a digital representation of a path traversed by said shopping cart in said retail establishment.

23. The optical odometer system of claim 22, further comprising means for storing timing information about the movement of said shopping cart along said path through said retail establishment.

24. The optical odometer system of claim 1 wherein said optics comprise a substantially telecentric lens.
